(19) United States
(12) Patent Application Publication
(10) Pub. No.: US 2013/0056668 A1
(43) Pub. Date: Mar. 7, 2013

(54) Offset type ball valve

(71) Applicant: Hans D. Baumann, W. Palm Beach, FL (US)

(72) Inventor: Hans D. Baumann, W. Palm Beach, FL (US)

(21) Appl. No.: 13/199,619

(22) Filed: Sep. 6, 2011

(51) Int. Cl. F16K 5/06

(52) U.S. Cl. 251/315.01

(57) ABSTRACT

The invention relates to offset-type ball valves utilized in fluid control applications requiring special relationships between the amount of passing fluid and the camming motion of a spherical element; and furthermore can provide leak proof shut-off when in the closed position. My invention, due to the absence of sliding plug seals, offers very little friction, making it ideal for throttling applications as part of automatic control systems.

### BACKGROUND OF THE INVENTION

This invention relates to temperature control systems typically used in office or apartment buildings in order to control the flow of hot or cold water, refrigerants, or steam.

Ball valves heretofore were a preferred type of flow control device used for this purpose.

U.S. Pat. No. 3,678,556 may serve to show the principle elements of construction of a ball valve. Here the flow controlling element is a ball 56 having a pierced opening 15 and being wedged between two compressed seal rings 36, typically made from a deformable plastic. This then creates a good deal of friction, whenever the ball is rotated from a given position. Such high friction requires large and costly operating devices on the one hand, and it also creates a hysteresis, or, dead-band effect whenever the travel is reversed from a given position, typically in automatic control applications. This dead-band translates into “dead time” using the parlance of automatic control theory. Such dead time, in turn causes instability of the control loop. In other words, it becomes very difficult to maintain a constant desired temperature.

My invention, on the other hand, overcomes these difficulties by providing a swinging ball, unhindered by any friction causing seals (save for a minor shaft seal). We therefore offer a device which is virtually dead-band free, and is therefore ideal for automatic control purposes.

In addition, my design has fewer parts and weighs at least 40% less than a comparable ball valve, an important economical advantage.

Finally, a wide-open ball valve has a bore through the ball, whose diameter is basically equivalent to the adjacent pipe size. Such a large port offers no fluid restriction and is therefore useless for control purposes. As a matter of fact, such valves have to operate at less than 50% open in order to generate a desired pressure drop (fluid restriction). This then restricts the controller's operating signal to only less than 50%. Here the dead-band has twice the negative impact on the available signal. My invention, on the other hand, can utilize close to 100% of the available travel for control purposes, another important advantage.

### BRIEF DESCRIPTION OF THE DRAWINGS

FIG. 1 is a longitudinal, cross-sectional view of a preferred embodiment of my invention.

FIG. 2 is an enlarged, cross-sectional, view along the lines 2-2 of FIG. 1.

FIG. 3 is a longitudinal, cross-sectional view of an alternate configuration of my invention.

FIG. 4 shows a cross-sectional view along the lines 4-4 of FIG. 3.

### DETAILED DESCRIPTION

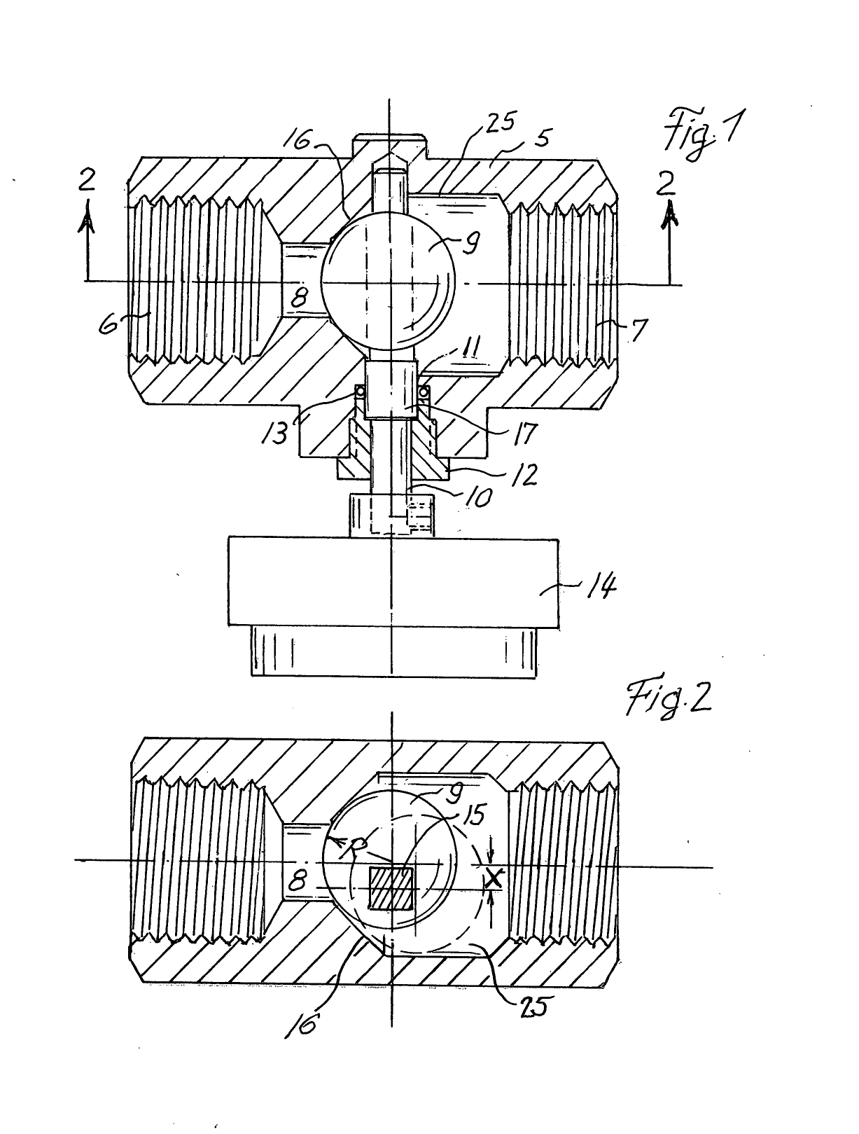

Referring to FIG. 1, where a preferred version of my rotary control valve is illustrated, it is comprised of a housing 5 having inlet 6 and outlet ports 7. Both ports are connected via an orifice 8, having a diameter of about 75% of the ball diameter, and capable of being opened or closed by a camming ball 9, the latter being motivated by a shaft 10, extending through a third opening 11 in housing 5.

Opening 11 encompasses a retainer 12 and a seal ring 13. Opening 11 and with it shaft 10 are off-set by a distance “X” from the centerline connecting both ports equivalent to about 20% of the radius “R” of the ball. This causes ball 9 to make a rotating or camming motion in and out of orifice 8 upon rotation of shaft 10, typically operated by an actuating device 14 (not part of my invention).

A portion 15 of shaft 10 passing through said ball is profiled, matching a similar profiled bore of the ball. This allows the shaft to transmit precisely rotary motion; yet, it allows the ball to slide freely along the length of shaft 10 in order to line up with the center of orifice 8. An enlarged cavity 25 within housing 5 allows the ball to freely rotate by 90 degrees as shown by dotted lines. Cavity 25 narrows in diameter into a conical section 16 towards orifice 8. This allows the ball to self-center itself against the orifice in order to provide tight shut-off. The relationship between the exposed flow area between housing interior surfaces and the ball, and the angular rotation of the stem is basically linear.

Shaft 10 furthermore has an enlarged diameter portion 17 co-operating with a similarly sized recess in retainer 12, thus preventing the shaft from being expelled from housing 5 by internal fluid pressures.

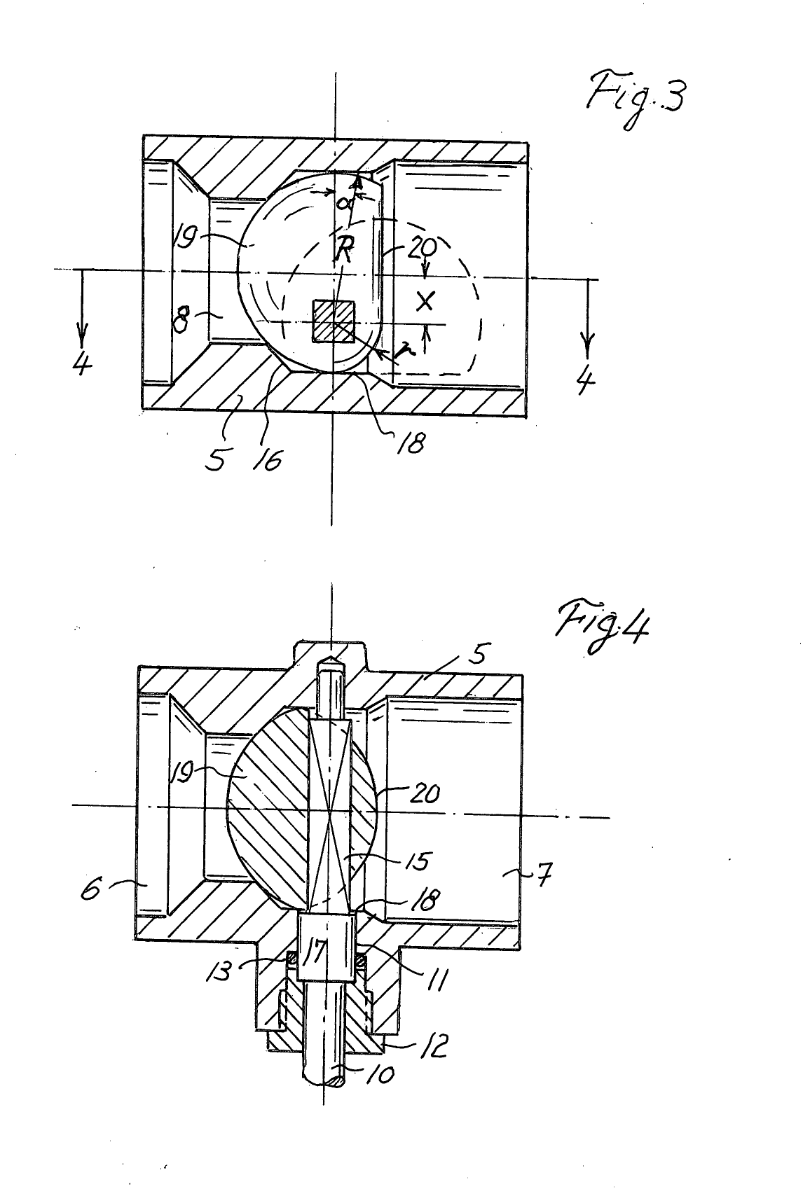

FIG. 3 shows the ball in an alternative, contoured configuration in order to achieve a logarithmic relationship of exposed flow areas between the housing interior and ball surfaces, and angular shaft displacement. Here the housing 5 has a cylindrical bore 18 extending from orifice 8. This bore is cooperating with the spherical radius “R” of a contoured ball 19. The lower halve of ball 19 has a smaller radius “r”, in order to allow ball 19 to rotate freely around the center of shaft 10, terminating into a curved section 20 designed to cradle into the lower half of bore 18, when the ball is at 90 degree travel (see dotted lines).

The controlled flow area, determining the amount of fluid passing the valve, is determined as follows: Any rotation of the shaft by an angle α will lower the upper surface of the ball by a distance d equal to the eccentricity “X” times one minus cosine α. This creates a flow area equal to d×R×π/2. The flow area is mostly dependent on the cosine of α, and since the cosine varies exponentially, we have a non-linear flow characteristic.

While my invention has been described in a preferred embodiment, nothing shall preclude from making additional modifications without departing from the scope of the following claims. For example, the shape of the section of the shaft connecting to the ball could have a serrated profile instead of a square, and the housing could have flanged ports instead of the shown pipe threads.

I claim:

1. An offset type ball valve comprising, a housing 1 having an inlet and an outlet port, an orifice disposed between said inlet and outlet ports, a ball, motivated to swing in an arc from and to said orifice in order to regulate the flow of fluid between said ports.

2. An offset type ball valve as in claim 1, wherein the diameter of said orifice is between 40 and 80 percent of the diameter of said ball.

3. An offset type ball valve as in claim 2, wherein said housing has a third opening extending at a centerline located perpendicular to an axis connecting said ports and said orifice, and wherein said axis of the third opening furthermore is vertically offset from the axis passing through said orifice.

4. An offset type ball valve as in claim 3, wherein the vertical distance between the center of said third opening and the axis passing through said orifice is between 12 and 25 percent of the diameter of said ball.

5. An offset type ball valve as in claim 4, wherein said ball has a pierced opening located eccentrically to the center of said ball and receiving therein a shaft passing additionally through said third opening within said housing.

6. An offset type ball valve as in claim 5, wherein said ball is capable to slide on said shaft in order to horizontally align its center with that of the orifice.

7. An offset type ball valve as in claim 3, wherein the third opening furthermore retains a sealing device capable of preventing fluid from escaping from the interior of said housing and along the outer surface of said shaft.

8. An offset type ball valve as in claim 7, wherein said sealing device is threadingly retained within said housing and furthermore has a shoulder contacting a similar shoulder as part of said shaft, capable of preventing fluid pressure from expelling said shaft from the housing's interior.

9. An offset type ball valve as in claim 2, wherein said housing furthermore has an enlarged bore located between said orifice and one of said ports, and wherein said enlarged bore reduces conically in diameter towards said orifice in order to provide a cradle for the swinging ball as it approaches said orifice.

10. An offset type ball valve as in claim 2, wherein said housing furthermore has an enlarged bore located between said orifice and one of said ports, and wherein said bore reduces into a cylindrical opening located adjacent to said orifice and wherein the diameter of said cylindrical opening is in tight relationship to the diameter of said ball in order to tightly control a portion of the fluid passing the valve utilizing the clearance between the spherical radius of said ball and the inner diameter of said opening.

11. An offset type ball valve as in claim 10, wherein the clearance between the spherical radius and the inside diameter of said cylindrical opening is given by the product of (1-cosine of the angle of shaft rotation)×the distance between the center of the shaft and the center of said ball.

12. An offset type ball valve as in claim 10, wherein said ball furthermore has a curved section having a radius originating at the center of said shaft and allowing said ball to rotate within the lower portion of the cylindrical opening when moving from the closed to the open position.

13. An offset type ball valve as in claim 12, wherein said curved section is in close contact, throughout the ball's travel, with the lower portion of said cylindrical opening in order to prevent fluid from by-passing the fluid controlling area given by the upper spherical radius of the ball and the upper radial portion of the cylindrical opening.
